(19) United States
(12) Patent Application Publication
(10) Pub. No.: US 2013/0213901 A1
(43) Pub. Date: Aug. 22, 2013

(54) DUAL SURFACE TEXTURED FILTRATION DEVICE & PROCESS

(71) Applicant: James Jeffrey Harris, Cameron Park, CA (US)

(72) Inventor: James Jeffrey Harris, Cameron Park, CA (US)

(21) Appl. No.: 13/400,408

(22) Filed: Feb. 20, 2012

(51) Int. Cl. B01D 29/00

(52) U.S. Cl. 210/767; 210/488

(57) ABSTRACT

A stacked annular ring filtration device and process are disclosed that provide high quality filtration without the burdens of differing ring types, filter size, flushing, or plugging impediments inherent in the prior art. The device comprises a stacked series of identical annular rings encircling a vacant circular center. Each ring has a textured filtration surface side and a dual channeled conduit surface side. The rings are stacked in a common orientation wherein the textured filtration sides always press on the channel conduit surface side of the adjacent ring. Filtration ensues by pressured dirty fluid entering the channels communicating external to the ring stack, traversing across the textured filtration surface of the adjacent ring, and issuing filtrate into the channels communicating with the vacant center of the ring stack. The solids imbued textured filtration surfaces are flushed clean by opening the stack and flushing, after which the stack is reassembled.

### BACKGROUND OF THE INVENTION

The present invention relates generally to filtration, and more particularly to a disk or ring type of filtration. High quality, fine grade filtration has been attempted in several fashions, but has failed to address problems especially related to particulate slippage as a consequence of ring rigidity and loss of filtration surface due to the excess ring thickness required for sufficient rigidity. Additionally, commercial configurations have been burdened by manufacturing difficulties and cost associated with said dual ring prior art. The present invention resolves the disadvantages and performance frailties associated dual ring filtration systems known in the art.

### BRIEF SUMMARY OF THE INVENTION

A ring filtration device and process are provided that facilitate a high quality, fine grade filtration without being burdened by ring flexibility, thickness and manufacturing and handling complexity associated with prior art requirements for two types of interacting rings.

In one embodiment, the filtration device of the present invention includes a single flat ring element with a hollow circular center with a textured surface on one side, the filtration side, and a channeled surface on the other side, the conduit side. The grooves being provided in two, alternating, non-intersecting, type of formats. One type of channel, the external channel, intersects the outer edge of the ring but does not intersect the inner edge; providing an externally communicating conduit for the ring. The other type of channel, the internal channel, intersects the inner edge of the ring but does not intersect the outer edge; providing an internally communicating conduit for the ring. The internal and external channels preferentially alternating about the channeled side of the very thin disk. In one embodiment, the internal channels and the external channels are configured in an alternating, equally spaced, spiral array about the conduit face of the very thin disk and are of substantially equal length with a glassy smooth surface between the channels. Additionally, in view of hydraulic considerations the channel widths should decrease as the radius decreases with the external channels and increase as the radius decreases with the internal channels while maintaining substantially equal channel wall to channel wall distance between the channels. Furthermore, in contrast to the dual ring configurations known in the art, filtration capacity is generated with only a single type of very thin ring wherein a plurality of such identical rings are simply stacked with the filtration side, and by proviso of design also the conduit side, being oriented in the same direction. In this arrangement, the filtration side of each ring contacts the conduit side of an adjacent ring and vice versa. Each ring in a substantially cylindrical stack of rings being axially rotatable relative to adjacent rings when not held together in a stack for filtration.

Inclusion of both a filtration surface and a conduit channel surface on a single ring advances the art over the author's prior art by eliminating the double depth of channels known in the art. This advance reduces the required thickness of the rings by nearly one half while purveying improved ring stiffness. Thickness reduction affords more rings per stack, bestowing increased filtration surface density and higher performance. Improved rigidity of the ring eliminates ring deformation and associated particle slippage flaws of the prior art.

The process of ring filtration generally includes the steps of contacting the filtration surface of one ring with the conduit surface of an adjacent ring; pressuring one or more fluids that contain suspended solids into the external conduit channels of the conduit surface, across portions of the contact area of said filtration surface and inter-channel areas of the channeled conduit surface, egressing from internal channels of said conduit surface, gathering said solids on said filtration surface; separating the adjacent rings and associated said filtration surface from said conduit channeled surface of said rings; washing said filtration surfaces and previously contacting channel surfaces to remove amassed solids; rotating the rings while washing or thereafter and bringing the washed surfaces back into filtration contact; and performing the above steps in repeated cycles. Whereas to one knowledgeable in the art an obvious similar embodiment would be flow in the opposite direction; whereas pressuring one or more fluids that contain suspended solids into the internal conduit channels of the conduit surface, across portions of the contact area of said filtration surface and inter-channel areas of the channeled conduit surface, egressing from external channels of said conduit surface would function similarly.

The foregoing has generally outlined the facets and technical benefits of the subject art so that a detailed description which follows may be easily understood. Additional facets and benefits of the subject art will be portrayed in the following which form the subject of the claims of the subject art. It should be appreciated by those skilled in the art that the conception and specific embodiment disclosed may be readily utilized as a basis for modifying or designing other structures or processes for carrying out the same purposes of the subject art. It should also be realized by those skilled in the art that such equivalent constructions do not depart from the spirit and scope of the subject art as set forth in the appended claims.

### BRIEF DESCRIPTION OF THE DRAWINGS

For a more complete understanding of the subject art, and the advantages thereof, reference is now made to the following descriptions taken in conjunction with the accompanying drawings, wherein:

FIG. 1 depicts a conduit side of a ring of the subject art illustrating an external and internal channel;

FIG. 2 depicts a filtration side view of a ring of the subject art illustrating a textured surface;

FIG. 3 is an exploded perspective depiction of a multiple ring stack illustrating a common orientation of each ring within the stack. Wherein this figure reveals the conduit face orientation of the rings in a stack of the subject art;

FIG. 4 is an exploded perspective depiction of a multiple ring stack illustrating a common orientation of each ring within the stack. Wherein this figure reveals the filtration face orientation of the rings in a stack of the subject art;

FIG. 5 depicts a cutaway detail of the interaction between two stacked rings elements of the subject art, exposing three conduit channels and associated flow patterns in and about the channels;

FIG. 6 is an elevation view of a stack of multiple identical rings of the subject art packed together in a unidirectional orientation for filtration; and

FIG. 7 is an elevation view of a stack of unidirectional, multiple identical rings of the subject art released and decompressed for washing.

### DETAILED DESCRIPTION OF THE PREFERRED EMBODIMENT

Information relating to the application, usage and benefits of various embodiments of the present invention are discussed in detail below. It should be appreciated, however, that the subject art provides many applicable inventive concepts that can be embodied in a wide variety of specific contexts. The specific embodiments discussed are merely illustrative of specific ways to make and use the subject art, and do not limit its scope. The subject art invention will be described with respect to preferred embodiments in a specific context, namely as a device and process for high quality, fine grade filtration. The subject art may also be applied, however, to other situations where filtration is desirable.

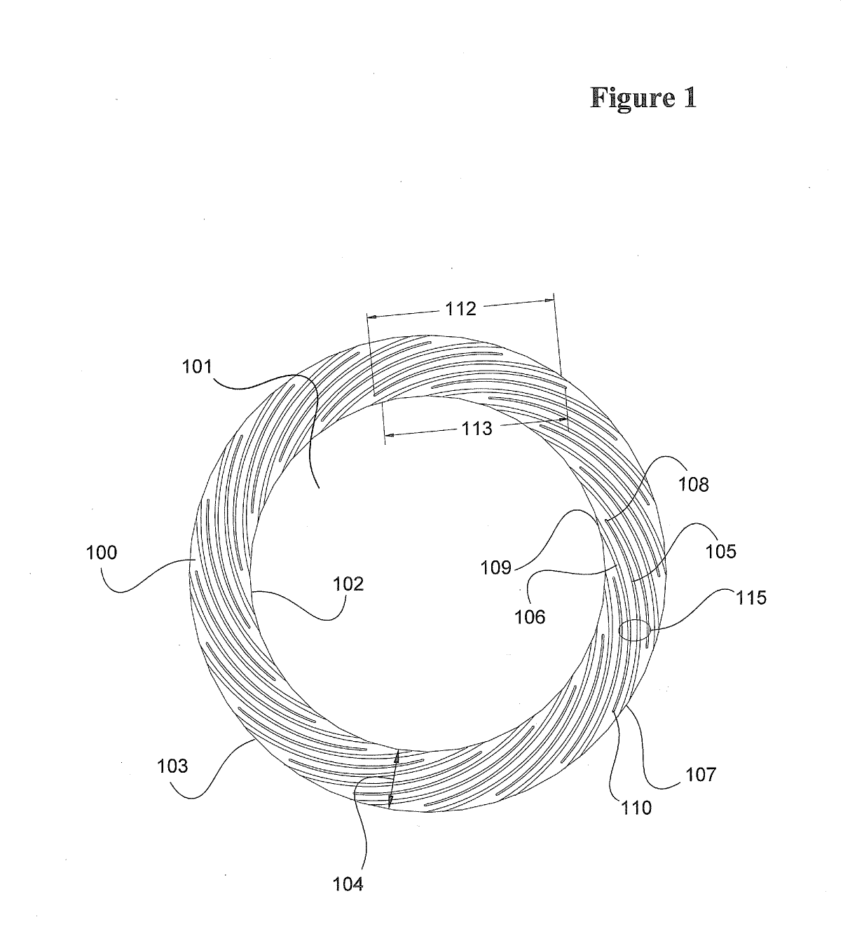

With reference now to FIG. 1, a view of a conduit side of a ring is depicted illustrating a series of internal and external communicating channels. The ring has a vacant circular center 100 with a ring width 104 as defined by an inner edge 102 and an outer edge 103. The conduit side 113 of the ring is glassy smooth and flat punctuated with external channels 105 and internal channels 106. As depicted on this illustration of this embodiment, the channels sweep out an array of alternating external 105 and internal 106 spiral channels courses upon the conduit surface of the ring. The external channels 105 begin at points similar to 107 at the outer edge 103 of the ring, spiraling inward, in a generally tapering format and terminating at points similar to 108 external to the inside edge 102. In a like fashion, internal channels 106 begins at points similar to 109 on the inside edge 102 of the conduit side of the ring spiraling outward in a tapering format mirroring the taper of the external channels 105. The internal channels 106 spiral outward terminating at points 110 interior to the outer edge 103 of the ring. The arc length 113 of the interior channel 106 and the arc length 112 of the exterior channels 105 are similar. The array configuration, the spiraling rate and the tapering rates are so chosen that the perpendicular distance between adjacent interior and exterior channel walls are nearly equidistant at all locations, as focused upon at typical area 115, within the radii of termination points 108 of the external and 110 of the internal channels.

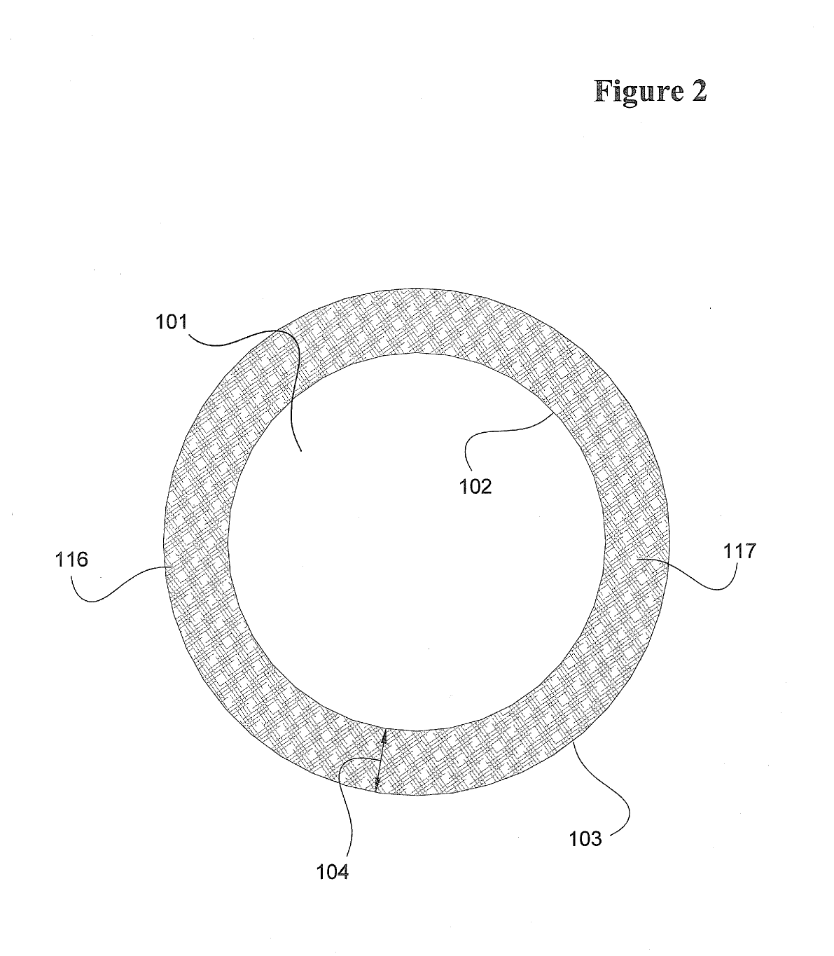

Referring to FIG. 2, a view of a filtration side 116 of a ring is depicted; having the same vacant circular center 101, with ring width 104 between outer edge of 103 and the inner edge of 102. The filtration side 116 of a ring is flat and textured with a grainy type of texture 117. The graininess of the texture 117 is varied to alter the grade of filtration; coarser grain generating coarser filtration.

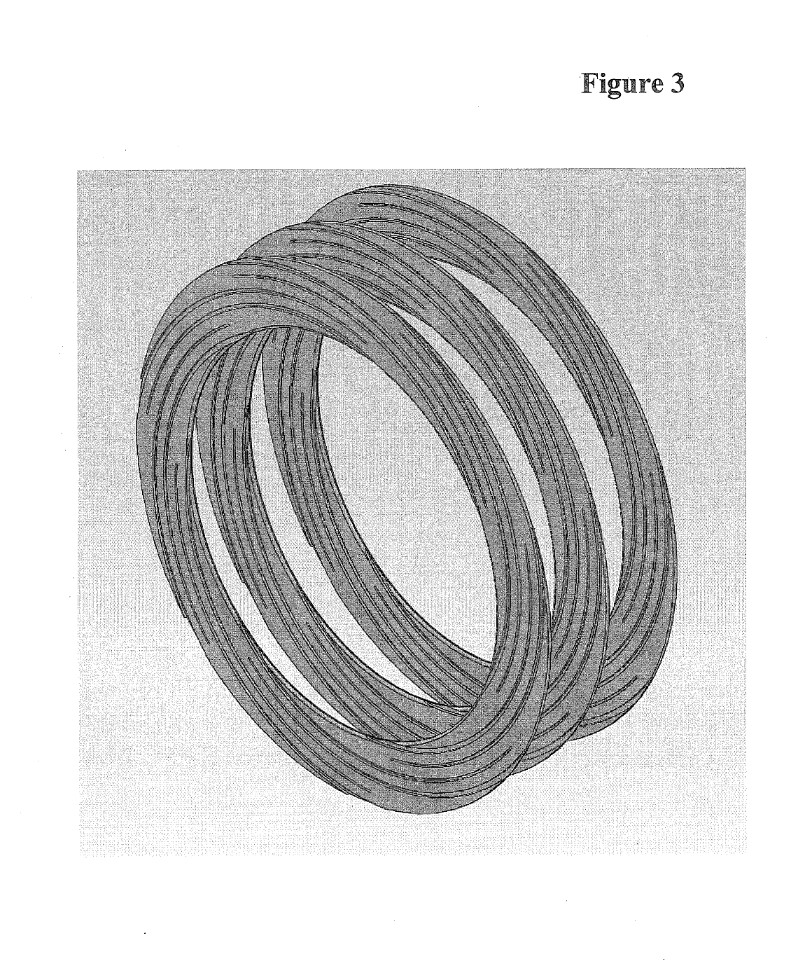

With reference now to FIG. 3, presented is an expanded view of a multiple ring stack illustrating the alignment of rings from a conduit side perspective.

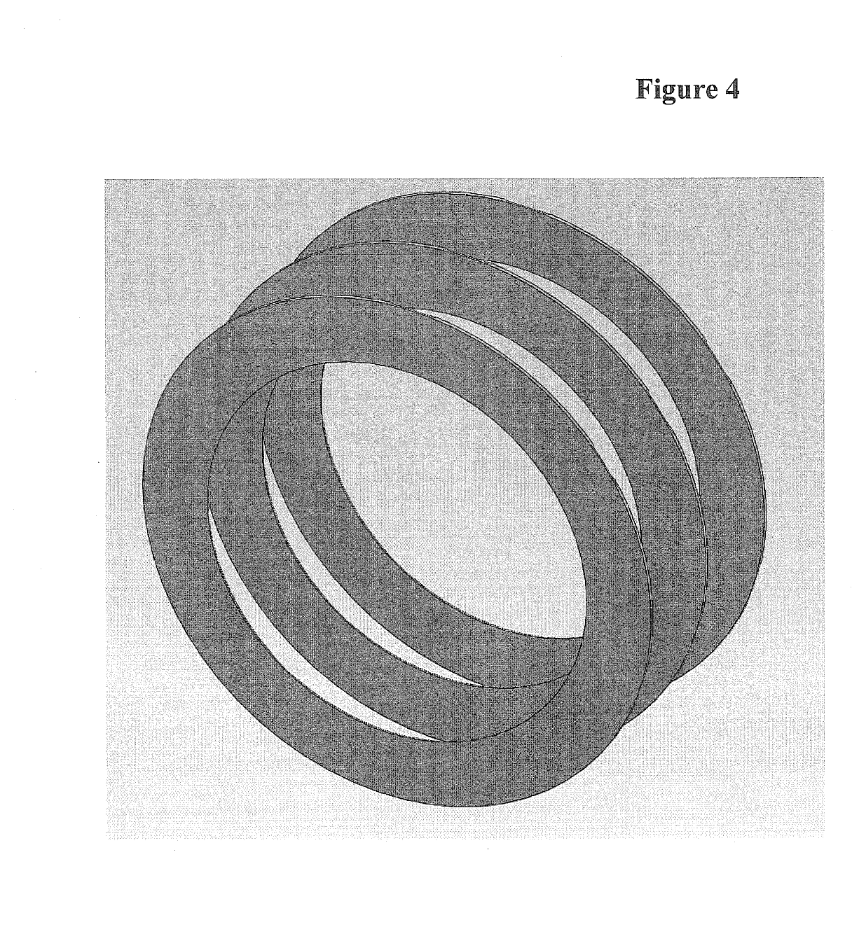

FIG. 4 illustrates the opposing view of FIG. 3, depicting an alignment view of an expanded stack of rings from a filtration side perspective.

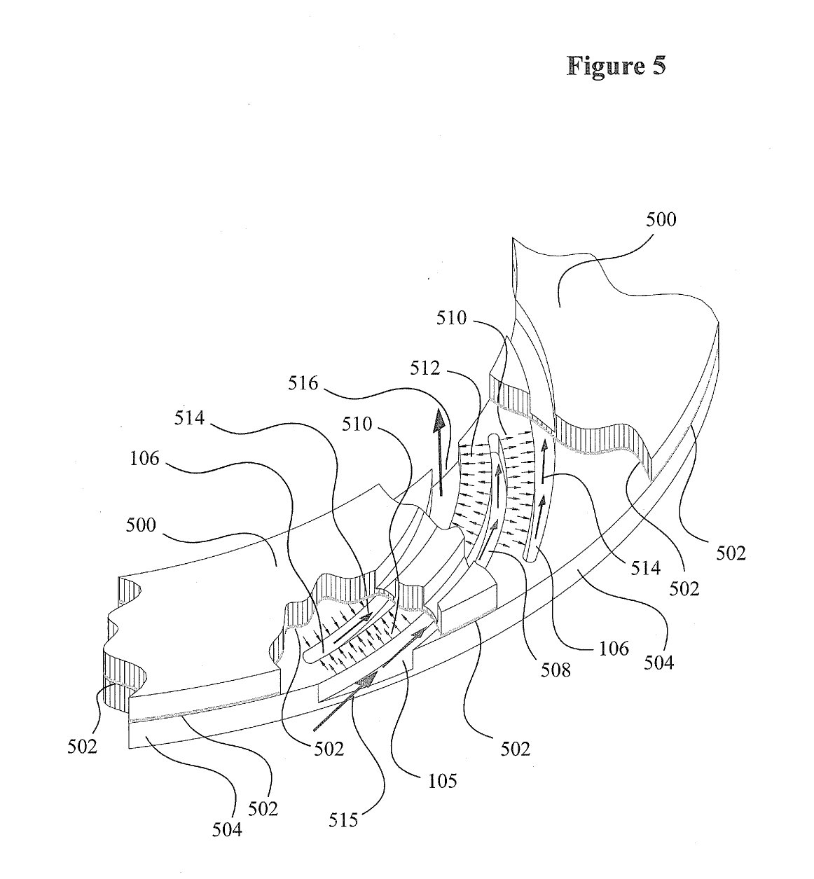

FIG. 5 conveys an illustration of the functional details of the subject art. This figure presents an isometric view of partial sections of two identical rings, an upper ring 500 and a lower ring 504, stacked in an operating configuration. The figure depicts both rings oriented with the conduit side facing upwards and the filtration side facing downwards. The two rings contact at surface areas delineated as 502 whereas the upward facing conduit side of ring 504 contacts the downward facing filtration side of ring 500. The conduit side of ring 504 is patterned with internal channels 106 and external channels 105. In operation, pressured solids entrained fluid 515 enters an external channel 105, conveying radially inward 508 along the spiraling channel 105. Pressure impels fluid 515 upon the overbearing filtration surface 502, effecting flow out of external channel 105 and along the textured filtration surface 502 towards the lower pressured adjacent internal channels 106. Solids are entrained within the textured filtration surface of 502 as fluid progresses tortuously along surface 502 progressing from solids entrained 510 to clean filtrate 512. Filtrate 512 discharges into adjacent internal channels 106 from which the filtrate conveys 514 to discharge 516.

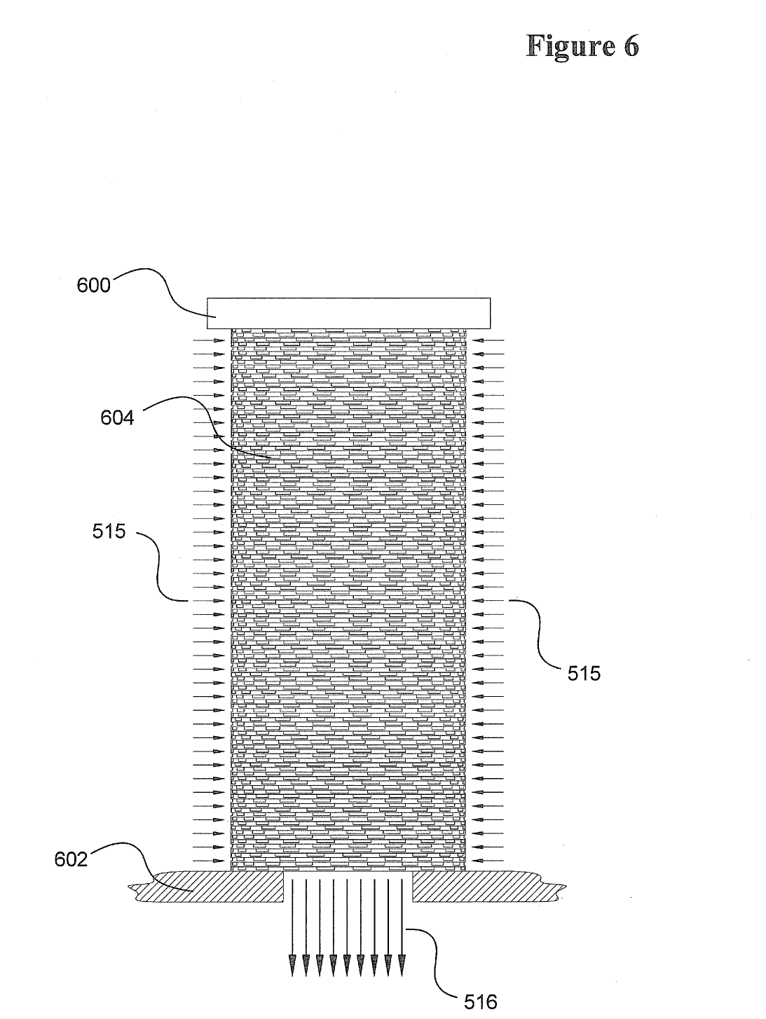

With reference now to FIG. 6; an elevation view of a stack of identical ring elements 604 of the present invention are shown, said elements being compressed between a ported base 602 and a sealing cap 600. The ring elements being similarly stacked wherein, as depicted in FIG. 6, the conduit face of each ring element is oriented upward and the filtration face of each ring element is oriented downward; affording conduit face to filtration face pressured contact throughout the stack. A reversed embodiment is equally feasible wherein the conduit face of each ring element faces downward and the filtration face of each ring element faces upward; also affording conduit face to filtration face pressured contact throughout the stack. In one embodiment of the subject art, the ported base 602 and the cap 600 both present a smooth sealing surface to the adjacent ring elements. Ceding, however, that two additional filtration area elements may be realized if either the ported base 602 or the cap 600 are oppositely textured as the filtration surface of a ring or channeled as a conduit surface of a ring and the orientation of ring elements of the stack is accordingly addressed.

In one embodiment, solids entrained fluid 515 is pressured external to the ring stack fostering flow in a filtering manner radially inward through the ring element stack, affording filtrate conveyance through the vacant center hollow of the ring element stack and egress 516 through ported base 602. A reverse flow embodiment is also feasible wherein solids entrained fluid is pressured through the ported base 602 into the vacant hollow center of the ring element stack wherein filtration occurs as the fluid passes radially outward through the rings purveying filtrate discharge from external to the ring stack.

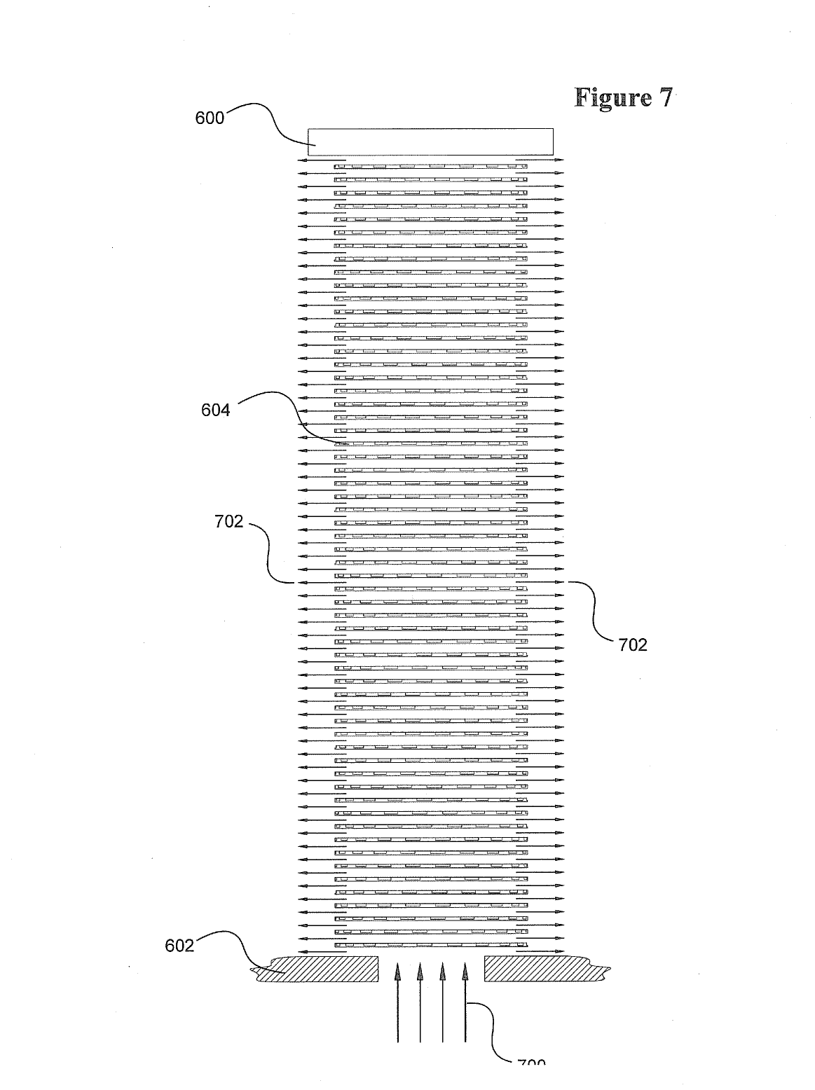

FIG. 7 depicts an expanded ring stack of FIG. 6 wherein cap 600 is withdrew from pressing contact with the ring element stack, affording vertical separation of the ring elements 604. Washing fluid 700 conveys in a reversed flow cleaning fashion between the separated ring elements 604, generally spinning, and scouring the ring surfaces, discharging the scoured solids external to the ring stack 702. Following the washing operation cap 600 is brought back into pressured contact with the ring stack elements, compressing the ring elements 604 back together for furtherance of filtration.

One unique aspect of the present invention is the rotational independence of contact between the conduit and filtration surfaces of the ring elements. Independent rotational displacements of adjacent filtration and conduit ring surfaces, which occurs during washing operations, affords regional variation of solids capture upon the textured filtration surfaces. This benefit uniformly distributes solids capture upon the textured filtration surface, eliminating areas of greater accumulations and the washing discrepancies which ensue.

Although the subject art and its advantages and benefits have been described in detail, it should be understood that various changes, substitutions and alterations can be made herein without departing from the spirit and scope of the subject art as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the subject art, processes, machines, manufacture, compositions of matter, means, methods, or steps, presently existing or later to be developed, that perform substantially the same function or achieve substantially the same result as the corresponding embodiments described herein may be utilized according to the subject art. Accordingly, the appended claims are intended to include within their scope such processes, machines, manufacture, compositions of matter, means, methods, or steps. Finally, in the foregoing discussion and in the claims, the terms “including” and “comprising” are used in an open-ended fashion, and thus should be interpreted to mean “including, but not limited to . . . ”.

What is claimed is:

1. A filtration device comprising:
an annular ring having an upper surface, a lower surface, an inner surface and an outer surface, said upper surface having a series of first conduit channels and series of second conduit channels, wherein said first conduit channels configured to be open from said inner surface outward approaching but not reaching said outer surface and said second conduit channels configured to be open from said outer surface inward approaching but not reaching said inner surface.

2. The filtration device of claim 1, wherein said lower surface is textured.

3. The filtration device of claim 1, wherein said first conduit channels alternate with said second conduit channels around said upper surface.

4. The filtration device of claim 1, wherein said internal channels and external channels are curved.

5. The filtration device of claim 1, wherein said first conduit channels taper from a larger cross section at said inner surface to a narrower cross section approaching the outer surface.

6. The filtration device of claim 1, wherein said second conduit channels taper from a larger cross section at said outer surface to a narrower cross section approaching the inner surface.

7. The filtration device of claim 1, wherein the distance between said first conduit channels and said second conduit channels is uniform across said upper surface.

8. A filtration system comprising: at least two annular rings, each having an upper surface, a lower surface, an inner surface and an outer surface, said upper surface having a series of first conduit channels and series of second conduit channels, wherein said first conduit channels configured to be open from said inner surface outward approaching but not reaching said outer surface and said second conduit channels configured to be open from said outer surface inward approaching but not reaching said inner surface; and wherein said more than two rings are configured such that the upper surface of one ring is adjacent to the lower surface of another ring.

9. The filtration system of claim 8, wherein said lower surface is textured.

10. The filtration system of claim 8, wherein said first conduit channels alternate with said second conduit channels around said upper surface.

11. The filtration system of claim 8, wherein said internal channels and external channels are curved.

12. The filtration system of claim 8, wherein said first conduit channels taper from a larger cross section at said inner surface to a narrower cross section approaching the outer surface.

13. The filtration system of claim 8, wherein said second conduit channels taper from a larger cross section at said outer surface to a narrower cross section approaching the inner surface.

14. The filtration system of claim 8, wherein the distance between said first conduit channels and said second conduit channels is uniform across said upper surface.

15. A filtration process comprising:
placing at least two annular rings adjacent to one another, each annular ring having an upper surface, a lower surface, an inner surface and an outer surface, said upper surface having a series of first conduit channels and series of second conduit channels, wherein said first conduit channels configured to be open from said inner surface outward approaching but not reaching said outer surface and said second conduit channels configured to be open from said outer surface inward approaching but not reaching said inner surface;
pressuring solids entrained fluid to said exterior surfaces of said two adjacent rings, wherein said fluid conveys in said second conduit channel into a contact area between said two adjacent rings whereupon said fluid exits said second conduit channel traversing along said textured filtration surface of the adjacent ring depositing solids thereon and solids free fluid issues as filtrate into said first conduit channel and exits through said inner surface.

16. The filtration process of claim 15, wherein said lower surface is textured.

17. The filtration process of claim 15, wherein said first conduit channels alternate with said second conduit channels around said upper surface.

18. The filtration process of claim 15, wherein said internal channels and external channels are curved.

19. The filtration process of claim 15, wherein said first conduit channels taper from a larger cross section at said inner surface to a narrower cross section approaching the outer surface.

20. The filtration process of claim 15, wherein said second conduit channels taper from a larger cross section at said outer surface to a narrower cross section approaching the inner surface.

21. The filtration process of claim 15, wherein the distance between said first conduit channels and said second conduit channels is uniform across said upper surface.
